(19) United States
(12) Patent Application Publication
(10) Pub. No.: US 2004/0182230 A1
(43) Pub. Date: Sep. 23, 2004

(54) Sound effects controller

(76) Inventors: Peter Anthony Vlant, Victoria (AU); Mario Sotiriadis, Victoria (AU)

Correspondence Address: Edwin D Schindler, Five Hirsch Avenue, PO Box 966, Coram, NY, 11727-0966, US

(21) Appl. No.: 10/485,058

(22) PCT Filed: Jul. 24, 2002
(86) PCT No.: PCT/AU02/00993

(51) Int. Cl. G10H 1/02; G10H 5/00

(52) U.S. Cl. 84/662

(57) ABSTRACT

A sound effects controller for controlling operation of at least one sound processing device includes an output connection for coupling at least one output of at least one sound processing device and a selection switch for selectively activating the at least one sound processing device. An additional switch is further included between the output connection and the selection switch for transferring the activated output of at least one sound processing device to the output connection. The sound effects controller may also include a device so that selections of different sound processing devices can be queued to enable ready selection of such different devices.

This invention relates to a sound effects controller and relates particularly, though not exclusively, to a musical effects controller for effects pedals for electric guitars.

In many guitar player's careers, there comes a time when they are unable to find an appropriate sound with their guitar and amplifier, no matter how much tweaking and fine-tuning is done In these situations, guitarists will often use effects pedals to alter their instrument's sound in a particular manner. There are many, many different types of effects that can be found for the guitar, for example, tremolo, wah wah, echo and so on. Each of these effects can be controlled by a separate effects pedal which must be connected to the amplifier and selected for operation when required. If many effects are required then a plurality of effects pedals are required with a proliferation of cables which are daisy chained together to connect them to the amplifier. Each effects pedal must be switched on at the required time and any number of these effects pedals can be operative at any one time. The continual switching of these devices is frustrating and a better solution is sought. In addition the number of cables required are unsightly and can lead to the guitarist tripping over one of them.

It is an object of the present invention to provide a sound effects controller which allows a plurality of sound processing devices to be selectively queued for operation and the queue to be released under user control.

A further preferred object of the invention is to provide a housing which contains said sound effects controller, connection means for said sound processing devices and said sound processing devices.

With these and other objects in view the present invention may provide a sound effects controller for controlling operation of at least one sound processing device, said controller including an output connection for coupling the output(s) of said at least one sound processing device and a selection switch means for selectively activating said at least one sound processing device.

Preferably said controller includes a further switch between said output connection and said selection switch means to transfer the activated output(s) of said at least one sound processing device to said output connection. Preferably a plurality of sound processing devices are coupled to said controller and each sound processing device is coupled to said selection switch means.

In a practical embodiment the sound processing devices are effects pedals for guitars and the effects pedals are located in a housing with said controller.

In a further aspect of the invention there may be provided a sound effects controller, said controller including an audio input connection from an audio signal to be processed, an audio output connection carrying the processed audio signal, connection means for at least one sound processing device having a respective audio input and a respective audio output which carries the processed audio signal, a first switching means to queue at least one of said at least one sound processing device for predetermined audio processing, and a second switching means for releasing said queue resulting in said predetermined audio processing occurring.

In a further aspect of the invention there may be provided a sound effects controller, said controller including an audio input connection from an audio signal to be processed, an audio output connection carrying the processed audio signal, connection means for a plurality of sound processing devices having respective audio inputs and respective audio outputs which carry the processed audio signal, a first switching means to queue at least one or more of said plurality of said sound processing devices for predetermined audio processing, and a second switching means for releasing said queue resulting in said predetermined audio processing occurring.

In order that the invention may be more readily understood and put into practical effect, reference will now be made to the accompanying drawings, in which:

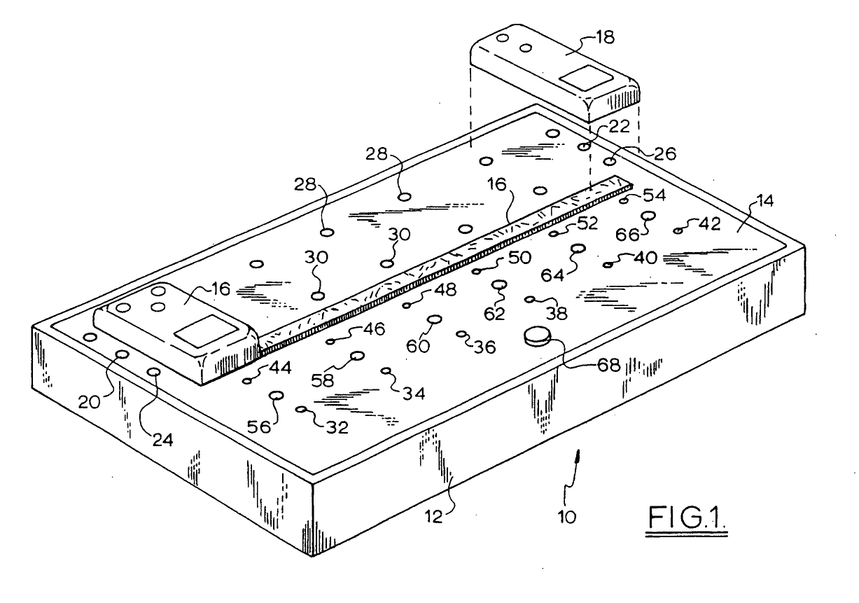

FIG. 1 is a perspective view of housing which includes the sound effects controller made in accordance with a preferred embodiment of the invention and showing the placement of effects pedals in the housing;

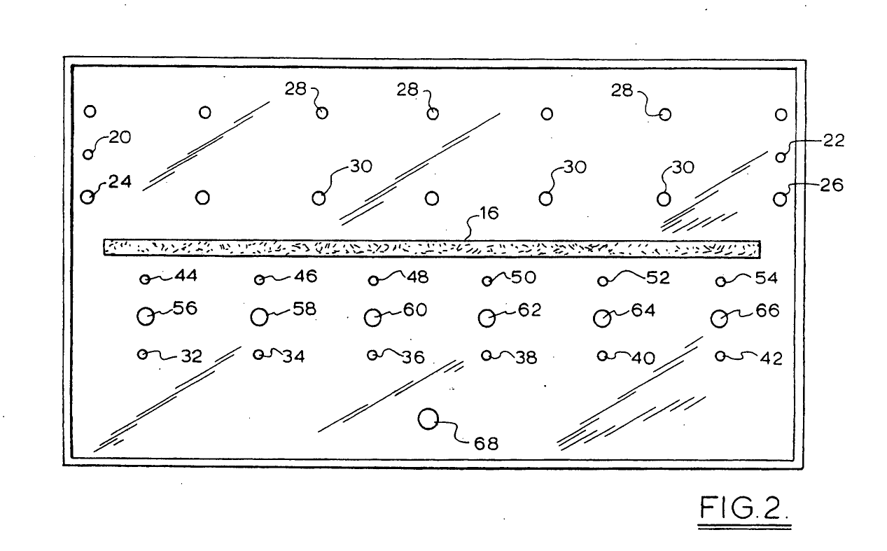

FIG. 2 is a plan view of the housing shown in FIG. 1 without the effects pedals;

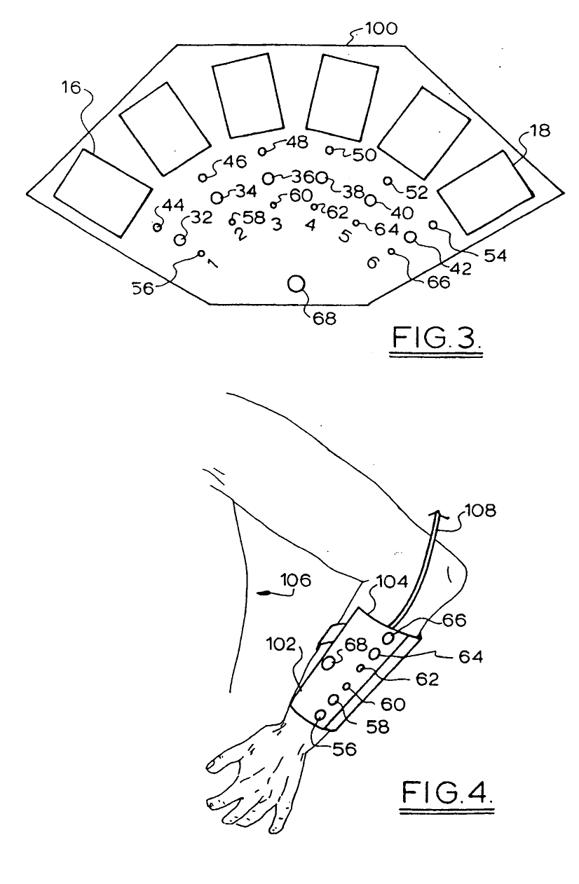

FIG. 3 is plan view of a second embodiment of a housing which includes the sound effects controller made in accordance with a preferred embodiment of the invention;

FIG. 4 is a perspective view of a third embodiment of the invention;

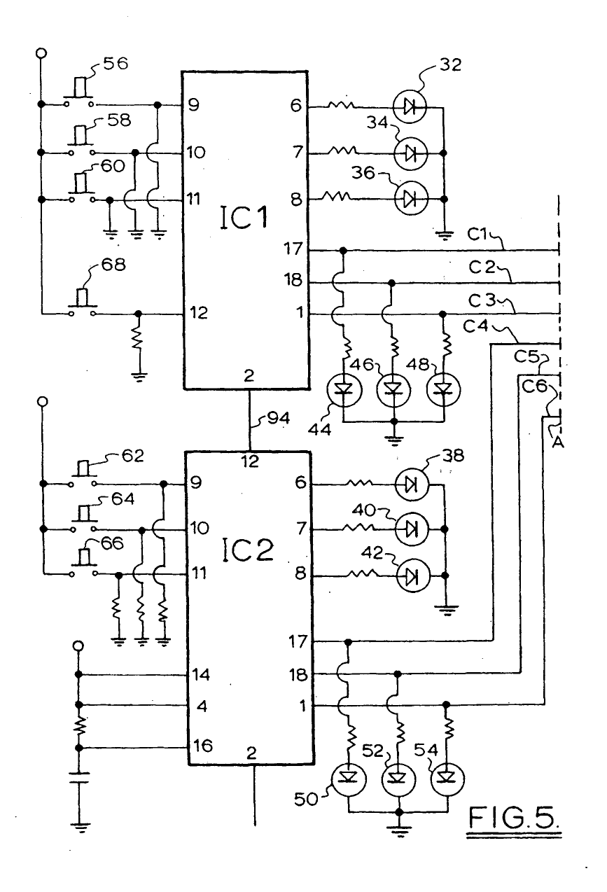

FIG. 5 is a circuit schematic drawing of a the first part of the circuit of the sound effects controller; and

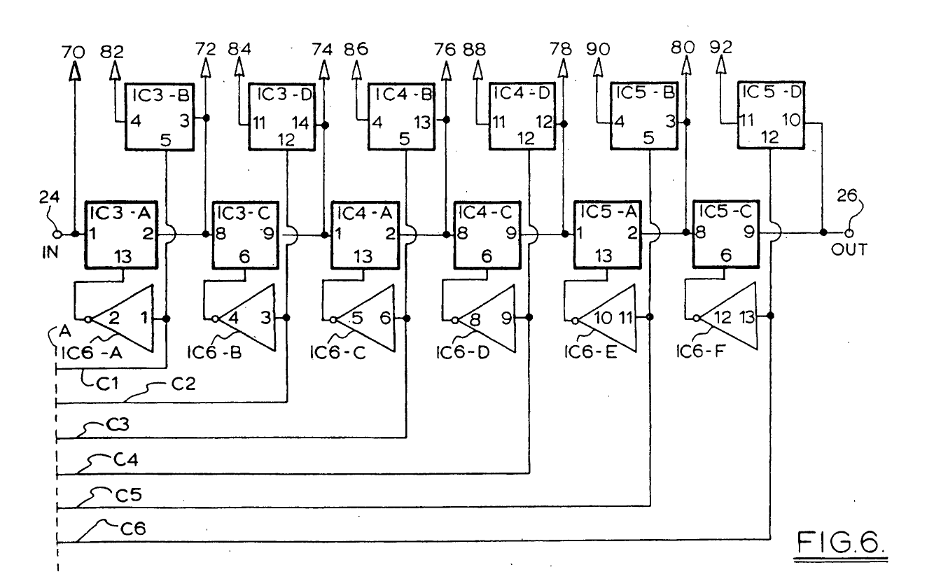

FIG. 6 is a circuit schematic drawing of a the second part of the circuit of the sound effects controller shown in FIG. 5.

In FIGS. 1 and 2 of the drawings there is shown a sound effects controller 10 which is fined inside a housing 12. The preferred embodiment will be described with reference to its use with effects pedals for guitars but the invention is not restricted to this particular use. The invention can be used where any audio signals need to be affected and/or gated whether musical or otherwise. Housing 12 can be made of aluminium or other suitable material which is strong and provides secure protection. A lid (not shown) with handle 30 can be releasably latched to housing 12 along opposing edges to completely cover housing 12 and secure the contents thereof. A face plate 14 provides visual indication of the components attached to the housing and contains switches and visual indicating means for operation of the controller. A strip of Velcro (Registered Trade Mark) is applied to face plate 14 to hold a plurality of effects pedals 16,18. FIG. 1 shows the use of two effects pedals but there is room for a total of six effects pedals. The controller of the invention can include provision for fewer or more effects pedals. The effects pedals 16,18 do not form part of the invention as they are standard stock items and are manufactured under the brand names of Boss, Sabine, Zoom and many others. Each effect pedal can change the sound of the guitar.

Controller 10 is provided with DC power from a regulated power supply that can be fitted inside housing 12 or from an external power supply. For use with an external power supply an input socket 20 is provided. A DC output socket 22 is provided to power the effects pedals connected to the controller. This connection can be made via a daisy chain cable (not shown). An audio input connection 24 allows the audio lead from the guitar (not shown) to be fed to the controller and the audio output from the controller is available at connection 26. Connections 28 allow fly leads to be attached to the audio inputs of respective effects pedals whilst connections 30 allow fly leads to be attached to the audio outputs of the effects pedals for coupling to controller 20.

Lights 44-54 are associated with a respective effects pedal 16,18 and provide a visual indication that its associated effects pedal is influencing the audio signal or is bypassed i.e. “status” of the respective effects pedals. Similarly lights 32-42 provide a visual indication that an associated effects pedal has been queued and will become active with the next depression of switch 68.

Switches 56-66 are known as the “queue” switches and are associated with a respective effects pedal. These switches are used to select/de-select a respective effects pedal and since these switches only change the queue, the selection can be altered indefinitely or until switch 68 is depressed. Switch 68 is the “transfer” button and simply transfers the selected effects pedals in the queue, making them active while simultaneously clearing the queue ready for a new selection. Switches 56-66,68 are preferably momentary push buttons whose status is read by microcontrollers IC1 and IC2 (FIG. 5).

FIGS. 5 and 6 show the circuitry of the controller 10 for controlling operation of effects pedals 16,18. FIG. 5 joins with FIG. 6 at join A shown on both FIGS. 5 and 6. A pair of microcontrollers IC1 and IC2 are shown in FIG. 5 to control operation of controller 10. In this embodiment the microcontrollers IC1, IC2 are identical and designated by the part number of PIC16F84 manufactured by Microchip Technology Inc. These microcontrollers are an 18 pin flash/EEPROM 8-bit microcontroller and are a commercially available product. No description of their operation will be given as this information is available from the data sheet for this product. Each microcontroller has a set of three switches coupled thereto and associated lights for indicating operation of controller 10. Microcontroller IC1 is coupled to switches 56-60 and associated lights 32-36 whilst microcontroller IC2 is coupled to switches 62-66 and associated lights 38-42. IC1 includes switch 68. Similarly lights 44-48 are associated with microcontroller IC1 and lights 50-54 are associated with microcontroller IC2.

A changeover switch for each effects pedal is formed from a combination of two bilateral switches and an inverter. For example, effects pedal 16 has an audio input 70 and an audio output 82. The audio input 24 is directly connected to audio output 70 and also to a bilateral switch IC3-A. IC3-A is one switch of a quad bilateral switch available from National Semiconductor under part number 4066. The control line for IC3-A comes from the output of an inverter IC6-A whose input is coupled to the control line of a further bilateral switch IC3-B and to a data line of microcontroller IC1. The inverter IC6-A is part of six such inverters available in a single package from National Semiconductor under part number 40106. The control of a further bilateral switch IC3-B also includes light 32. The output from bilateral switch IC3-A is coupled to a corresponding bilateral switch IC3-C which forms a part of the next changeover switch for the next effects pedal attached to connections 72,84. The output of bilateral switch IC3-B is fed to the audio input of the next effects pedal. As can be seen from FIG. 6 there are a further five changeover switches which are associated with the other effects pedals. The integrated circuits IC4 and IC5 are also National Semiconductor part numbers 4066. The function of these other changeover switches are identical to that described with reference to effects pedal 16 and will not be further described.

In use, microcontrollers IC1,IC2 will monitor switches 56-68, perform all control functions and drive all lights 32-54. Microcontrollers IC IC2 will run identical programs and are connected as a master-slave combination with microcontroller IC1 monitoring switch 68. A transfer line 94 links the two microcontrollers and confirms the status of switch 68. Additional microcontrollers can be daisy chained together if more than six effects pedals are needed. Controller 10 is set up as shown in FIG. 1 and in this example only two effects pedals 16,18 are shown connected. The audio input of effect pedal 16 is coupled to audio output 70 whilst the audio input of effect pedal 18 is coupled to audio output 80 and audio output of effect pedal 16 is coupled to audio input 82 whilst the audio output of effect pedal 18 is coupled to audio input 92. When the effects pedals 16,18 are turned on with controller 10, the microcontrollers IC1,IC2 will be initialized and all lights 32-54 will be extinguished. Control lines C1-C6 are held low by microcontrollers IC1,IC2 allowing the output of IC6-A to be high which turns on IC3-A. Simultaneously IC3-B is turned off as its control line is also held low. Accordingly, the unprocessed signal 24 from the guitar will be passed through to the next output 72. As bilateral switch IC3-B is off, the processed signal from effects pedal 16 through input 82 is blocked. In this mode the raw signal from the guitar at 24 will be passed directly through to output 26 without modification. The other changeover switches will operate in a similar manner.

If effects pedal 16 is required, then switch 56 is depressed. Microcontroller IC1 will detect this depression and illuminate light 32 to indicate it has been queued. Switches 56-66 will act as toggles with one depression selecting the particular effects pedal whilst the next depression will deselect the effects pedal. More than one effects pedal can be selected by depressing its associated switch. The effect will not be operable as control lines C1-C6 will reflect the last selection. These operation(s) will result in the selected effects pedal(s) being queued for operation. When the effect(s) are required for use then switch 68 is depressed which will act as a transfer button to clear the queue and allow the effect(s) to be transmitted. The selected effects pedal(s) will have their associated control line C1-C6 to be held high by microcontrollers IC1,IC2. In the example, as only effect pedal 16 has been selected, only control line C1 will be held high by microcontroller IC1 with light 44 being illuminated. Accordingly, the output of inverter IC6-A will go low which in turn turns off switch IC3-A. Thus the signal from the preceding stage will be blocked by switch IC3-A. As the control line for switch IC3-B is high then this switch will be turned on and the processed signal 82 from effects pedal 16 will be passed to the input of the next changeover switch and so on. The processed signals from the selected effects pedal(s) will continue until switch 68 is depressed

In FIG. 3 there is shown a second embodiment of a controller 100 which operates identically to controller 10. The shape of the housing has changed together with a re-arrangement of the lights and switches. The corresponding integers in FIGS. 1 and 2 have been given the same reference numerals to avoid duplication of description. The construction and appearance of the controllers 10,100 can be varied to suit particular applications.

In FIG. 4 a third embodiment is shown where switches 56-68 have been duplicated on an arm band 102 worn on the arm 104 of a guitar player 106. A cable 108 links back to controller 10,100 to allow remote operation of the controller. This option will allow more freedom for the guitar player and will obviate the need to go back and forwards to the location of the controller. For additional freedom. Cable 108 could be replaced by a cordless device e.g. an infrared remote control device for switches 56-68.

It can be seen that the effects pedals are always turned on which avoids any switch on delays common to these devices. The microcontrollers will switch the effects immediately and as seen from the circuit description the effects pedals are wired in series through controller 10 therefore the effect from each stage is cumulative. By having the effects pedals in a single housing the stage is a lot safer for the performer and access and set up to the effects pedals is simplified.

When the performance is complete the controller can be packed up quickly and the effects pedals will be safely secured in the housing. 10

Although the preferred embodiment has been described with reference to particular components it is clear to the man skilled in the art that the invention is not limited to such components. The microcontrollers can be readily changed as can the switches and triggers. Discrete components could be substituted if required. The programming of the microcontrollers can also be changed to provide additional features or variations to the operation of the controller.

The invention will be understood to embrace many further modifications as will be readily apparent to persons skilled in the art and which will be deemed to reside within the broad scope and ambit of the invention, there having been set forth herein only the broad nature of the invention and a certain specific embodiments by way of example.

We claim:

1. A sound effects controller for controlling operation of at least one sound processing device, said controller including an output connection for coupling the output(s) of said at least one sound processing device and a selection switch means for selectively activating said at least one sound processing device.

2. A sound effects controller as claimed in claim 1 wherein the controller includes a further switch between said output connection and said selection switch means to transfer the activated output(s) of said at least one sound processing device to said output connection.

3. A sound effects controller as claimed in claim 1 or claim 2 in which a plurality of sound processing devices are coupled to said controller and each sound processing device is coupled to said selection switch means.

4. A sound effects controller as claimed in any one of claims 1 to 3 wherein the sound processing devices are effects pedals for guitars and the effects pedals are located in a housing with said controller.

5. A sound effects controller as claimed in any preceding claim including first switching means to queue at least one sound processing device for predetermined audio processing and a second switching means for releasing said queue resulting in said predetermined audio processing occurring.

6. A sound effects controller, said controller including an audio input connection from an audio signal to be processed, an audio output connection carrying the processed audio signal, connection means for at least one sound processing device having a respective audio input and a respective audio output which carries the processed audio signal, a first switching means to queue at least one of said at least one sound processing device for predetermined audio processing, and a second switching means for releasing said queue resulting in said predetermined audio processing occurring.

7. A sound effects controller, said controller including an audio input connection from an audio signal to be processed, an audio output connection carrying the processed audio signal, connection means for a plurality of sound processing devices having respective audio inputs and respective audio outputs which carry the processed audio signal, a first switching means to queue at least one or more of said plurality of said sound processing devices for predetermined audio processing, and a second switching means for releasing said queue resulting in said predetermined audio processing occurring.
